(19) United States
(12) Patent Application Publication
(10) Pub. No.: US 2025/0212268 A1
(43) Pub. Date: Jun. 26, 2025

(54) Enhanced Service Continuity

(71) Applicant: Telefonaktiebolaget LM Ericsson (PUBL), Stockholm (SE)

(72) Inventors: Attila Mihály, Dunakeszi (HU); Mirja KUEHLEWIND, Ludwigsburg (DE); Marcus Ihlar, ÄLVSJÖ (SE); Magnus Westerlund, Upplands Väsby (SE)

(21) Appl. No.: 18/852,123

(22) PCT Filed: Mar. 31, 2023
(86) PCT No.: PCT/EP2023/058575

§ 371 Date: Sep. 27, 2024

(30) Foreign Application Priority Data
Apr. 1, 2022 (WO) PCT/EP2022/058799

(51) Int. Cl. H04W 76/12; H04L 67/141

(52) U.S. Cl. CPC H04W 76/12; H04L 67/141

(57) ABSTRACT

A method in a wireless communication system for service continuity between a user equipment, UE, based client application and a server, the connection comprising an edge application server, the connection further comprising a first local user plane proxy function and a user plane tunnel connection between the UE based client and the first user plane proxy function, the user plane tunnel connection further comprising a first source internet protocol, IP, address, the method comprising: inserting (910) a second user plane function between the UE based client and the server, providing (920) a second source IP address for uplink, UL, data packets, wherein the second source IP address is different from the first source IP address; forwarding UL (930) data packets from the second user plane function to the first user plane proxy function, wherein the first source IP address is replaced with the second source IP address; initiating (940) a path change procedure between the UE based client and the first user plane proxy function in response to the change to the second source IP address.

### TECHNICAL FIELD

Embodiments herein relate generally to a wireless communication system and more specifically to methods and apparatus configured to perform enhanced service continuity.

### BACKGROUND

The next generation (5G) networks architecture is defined in the 3GPP from Rel15. FIG. 1 depicts the 5G reference architecture as defined by 3GPP TS 23. 501 V17.3.0 for example.

In relation to FIG. 1, for a wireless communication system, 100, comprises an SMF (Session Management Function), 118, that is responsible for Session establishment, modification and release, including selection and control of a user plane function (UPF) entity or entities, 126, maintaining the topology of an involved protocol data unit (PDU) session anchor (PSA) UPF, establishing and releasing the tunnel between an AN 124 and the UPF 126, i.e. interface N3, 158, and between multiple UPFs 126, i.e. interface N9, 162. The SMF, 118, also configures traffic forwarding at the UPF 126. SMF 118 interacts with the UPF 126 over N4 Reference point 154 using packet forwarding control protocol (PFCP) procedures. The UPF, 126, handles user data traffic. Among other functions, the UPF 126 provides an external PDU Session point of interconnect to a Data Network 128, also referred to as PDU session anchor (PSA). The UPF 126 may also perform packet routing & forwarding (e.g. support of Uplink classifier (UL CL) to route traffic flows to an instance of a data network and support of Branching Point (BP) to support multi-homed PDU Session).

A policy control function (PCF), 108, supports a unified policy framework to govern the network behavior. Specifically, for this invention, the PCF provides policy and charging control (PCC) rules to a policy and charging enforcement function (PCEF), i.e. the SMF/UPF 118/126 that enforces policy and charging decisions according to provisioned PCC rules.

Edge computing enables operator and 3rd party services to be hosted close to the UE's 122 access point of attachment, in order to achieve an efficient service delivery through the reduced end-to-end latency and load on the transport network. The 5G Core Network selects a UPF 126 close to the UE 122 and executes the traffic steering from the UPF to the local Data Network 128 via an N6 interface, 160.

A number of enablers have been defined that alone or in combination support Edge Computing (clause 5.13. in TS 23.501 V17.4.0. Among those:
User plane (re) selection: the 5G Core Network (re) selects UPF to route the user traffic to the local Data Network as described in clause 6.3.3 in TS 23.501 V16.11.1;
Local Routing and Traffic Steering: the 5G Core Network selects the traffic to be routed to the applications in the local Data Network; this includes the use of a single PDU Session with multiple PDU Session Anchor(s) (uplink classifier (UL CL)/IP v6 multi-homing) as described in clause 5.6.4 in TS 23.501 V16.11.1;
Session and service continuity to enable UE and application mobility as described in clause 5.6.9 in TS 23.501 V16.11.1.

Further enhancements for service continuity during edge relocation have been proposed for 3GPP Rel17 in TS 23.548 V17.1.0. The document defines the following connectivity models to enable Edge Computing:
Distributed Anchor Point: For a PDU session, the PSA UPF is in a local site, i.e. close to the UE location.
Session Breakout: A PDU Session has a PSA UPF in a central site (C-PSA UPF) and one or more PSA UPF in the local site (L-PSA UPF). The C-PSA UPF provides the IP Anchor Point when UL Classifier is used. The Edge Computing application traffic is selectively diverted to the L-PSA UPF using UL Classifier or multi-homing Branching Point mechanisms (CL/BP). The L-PSA UPF may be changed due to e.g. UE mobility.
Multiple PDU Sessions: Edge Computing applications use PDU. Session(s) with a PSA UPF(s) in local site(s). The rest of applications use PDU Session(s) with PSA UPF(s) in the central site(s).

FIG. 2 illustrates the three connectivity models, as described above, denoted A), B) and C).

Edge relocation refers to the procedures supporting edge application server (EAS) changes and/or PSA UPF (i.e., UPF acting as Packet Switched Anchor) changes. Edge Relocation may be triggered by an AF request (e.g. due to the load balance between EAS instances in the edge hosting environment) or by the network (e.g. due to the UE mobility). With Edge Relocation, the user plane path changes and the main optimization issue is how to provide service continuity for the ongoing services while the path changes.

FIG. 3 shows example relocation scenarios while the UE 122 moves, where the continuous line 305 shows the original user plane path, which is provided by the system areas 310 (e.g. radio access network providing radio interface user plane and packet core network infrastructure comprising IP routers etc) for UPF #1 320, wherein the UE 122 is operating an App which is hosted by EAS #1, 330. A new user plane path, depicted by the dashed line 340 may be established at PSA relocation 350. The user plane is connection is provided by the system areas 360 for UPF #2 370. Note that the new user plane path 340 is shown tunneled back to UPF #1 in order to provide the same IP point of presence for the UE towards the Server EAS #1 330. In some examples the new user plane path may be routed to a new server EAS #2 380 at both PSA and EAS relocation, this is shown by dotted line 390.

5G networks allow from 3GPP R16 simultaneous connectivity to an Application via an existing (e.g. initial or pre-relocation path), e.g. a first PSA and new e.g. a second PSA at relocation that in turn allows the application to build its own Server (EAS) relocation solution and minimize the impact on latency.

Distributed Anchor or Multiple Sessions are described in clause 4.3.5.2 of TS 23.502 V17.4.0 for Change of Service and Sesson Continuity (SSC) mode 3 PDU Session Anchor with multiple PDU Sessions and in clause 4.3.5.3 for Change of SSC mode 3 PDU Session Anchor with IPV6 Multi-homed PDU Session. Session Breakout is described in clause 4.3.5.7 of TS 23.502 for Simultaneous change of Branching Point or UL CL and additional PSA for a PDU Session. In TS 23.548 V17.1.0 it is procedures for Edge Application Server (EAS) discovery as well as enhancements for Edge Relocation are described.

Traffic encryption is growing significantly in mobile networks and at the same time, the encryption mechanisms are growing in complexity. In particular, most applications today are not based on HyperText Transfer Protocol (HTTP) cleartext, see IETF RFC 7235, but instead they are based on HTTPS (HTTP using Transport Layer Security, TLS, see e.g. IETF RFC 8446). Additionally, a significant part of the traffic is based on Quick UDP (User Datagram Protocol) Internet Connections (QUIC) transport protocol, IETF RFC 9000, (some examples being YouTube, Facebook). QUIC has an encryption also on the transport protocol headers.

### SUMMARY

In some embodiments a method of handling service continuity at edge relocation, in which a Client tunnels its connections through a local Proxy, for example a QUIC proxy, whereby at a PSA relocation, a Target PSA (UPF) forwards Client traffic to the Proxy while re-writing the source IP address of the Client traffic. The Proxy detects the Client IP change and triggers a transport layer notification or tunnel control message to the UE, informing it of the PSA change. Additionally the proxy may inform the UE about a new local Proxy configuration to be used for further connections. The Client may initiate a re-connect to the new, more optimal, Proxy through the Target PSA and start Server re-discovery.

Embodiments enable the application clients to handle the relocation in the same way regardless which connectivity model is used, simplifying implementation and signaling. In some embodiments problems related to WIFI-3GPP nomadicity are mitigated such that WIFI access may be handled in the same way as for Distributed Anchor/Multiple Sessions connectivity models from a client perspective.

Some embodiments advantageously support completely agnostic application clients, providing in this way backward compatibility to a pre-existing eco-system. In such examples the UE (typically the OS) i) captures in an application agnostic way the application traffic, ii) establishes the QUIC tunnel to the Proxy, iii) migrates the QUIC connection to the Proxy, iv) re-connects to the new Proxy if needed, and v) sends a re-discovery indication to the application, if such an internal API is available. In other examples, re-discovery of the new Server through the new Proxy is left to the application layer, for example via a Server re-direct message to the application or an application client may issue a re-discovery based on the expiry of an internal timer (e.g., DNS cache entry time-to-live).

In some examples the Proxy provides additional support to the client during (re-) discovery process e.g. pre-discovery of Server transport protocol capabilities, delegated Server discovery etc. In further examples, multi-path support in the Proxy and Client enables the use of multiple accesses towards the same Server simultaneously for multiple sessions or multi-homed IPv6 session (also for TCP Servers).

### BRIEF DESCRIPTION OF THE DRAWINGS

FIG. 1 is a block diagram illustrating an example network environment according to embodiments of the present disclosure.

FIG. 2 is a block diagram illustrating connectivity scenarios according to embodiments of the present disclosure.

FIG. 3 is a block diagram illustrating mobility scenarios according to embodiments of the present disclosure.

FIG. 4 is a block diagram illustrating connectivity via a QUIC proxy according embodiments of the present disclosure.

FIG. 5 is a signalling diagram according to one or more embodiments of the present disclosure.

FIG. 6 is a signalling diagram according to one or more embodiments of the present disclosure.

FIG. 7 is a signalling diagram according to one or more embodiments of the present disclosure.

FIG. 8 is a signalling diagram according to one or more embodiments of the present disclosure.

FIG. 9 is a flow diagram according to one or more embodiments of the present disclosure.

FIG. 10 is a flow diagram according to one or more embodiments of the present disclosure.

FIG. 11 is a flow diagram according to one or more embodiments of the present disclosure.

FIG. 12 is a flow diagram according to one or more embodiments of the present disclosure.

FIG. 13 is a block diagram illustrating an example of a user equipment according to one or more embodiments of the present disclosure.

FIG. 14 is a block diagram illustrating an example of a first proxy function according to one or more embodiments of the present disclosure.

FIG. 15 is a block diagram illustrating an example of a second proxy function according to one or more embodiments of the present disclosure.

FIG. 16 depicts an example communication system according to one or more embodiments of the present disclosure.

FIG. 17 is a block diagram illustrating an example of a user equipment according to one or more embodiments of the present disclosure.

FIG. 18 is a block diagram illustrating an example of a network node according to one or more embodiments of the present disclosure.

FIG. 19 is a block diagram illustrating an example of a host server according to one or more embodiments of the present disclosure.

FIG. 20 is a block diagram illustrating an example of a vitualized network node according to one or more embodiments of the present disclosure.

FIG. 21 is a block diagram illustrating an example of a communication network providing an OTT service connection according to one or more embodiments of the present disclosure.

### DETAILED DESCRIPTION

QUIC (IETF RFC 9000) is a stream-multiplexed and secure transport protocol with integrity protected header and encrypted payload. Unlike the traditional transport protocol stack with TCP (Transmission Control Protocol), which resides in the operating system kernel, QUIC can easily be implemented in user space, i.e. in the application layer. As a consequence, this improves flexibility in terms of transport protocol evolution with implementation of new features, congestion control, deploy ability and adoption. It is expected that most web apps will be based on QUIC transport. QUIC is considered to become a predominant transport protocol in the Internet's user plane. It is expected that many applications running today over HTTP/HTTPS will migrate to QUIC, driven by latency improvements and stronger security. Notably, compared to HTTPS, encryption in QUIC covers both the transport protocol headers as well as the payload, as opposed to TLS over TCP, e.g. HTTPS, which protects only the payload.

Conceptionally, a proxy is an intermediary program acting as both server and client, creating or simply relaying requests on behalf of other entities. Requests are serviced internally or by passing them on, with possible translation, to other servers. There are several types of proxies, for brevity, the following main types are described:
A “transparent proxy” is a proxy that does not modify the request or response beyond what is required for proxy authentication and identification.
A “non-transparent proxy” is a proxy that modifies the request or response to provide some added service to the user agent, such as group annotation services, media type transformation, protocol reduction, or anonymity filtering.
A “reverse proxy” basically is a proxy that pretends to be the actual server (as far as any client or client proxy is concerned), but it passes on the request to the actual server that is usually sitting behind another layer of firewalls.
A “Performance Enhancement Proxy (PEP)” is used to improve the performance of protocols on network paths where native performance suffers due to characteristics of a link or subnetwork on the path.

The IETF is developing mechanisms that allow configuring and concurrently running multiple proxied stream- and datagram-based flows inside an HTTPS connection. These mechanism(s) are collectively termed Multiplexed Application Substrate over QUIC

Encryption (MASQUE). HTTP and/or HTTP/3 extensions of the CONNECT method to enable this functionality, e.g. CONNECT-IP for proxying arbitrary IP packets are expected to be specified by the IETF.

A Collaborative Performance Enhancement (COPE) node or function is an entity which resides between two endpoints, usually in a client and server setup but also in a peer to peer communication setup, that use encrypted communication. The communicating parties (e.g. the client) explicitly contact the proxy in order to request a network-support service. This service, for example, based on MASQUE, at a minimum always includes forwarding of the encrypted traffic to a specific server, e.g. also in cases where the server is otherwise not directly reachable. In addition, the endpoints can share traffic information with the COPE entity such that the COPE entity can execute a requested performance enhancement function to improve the Quality of Service (QOS) of the traffic as well as optimize operations within the network.

Alternatively or additionally the COPE node may provide further or additional information about the network which enables the endpoint to optimize its data transfer. In some examples the COPE node may use a more optimized congestion control or delay pre-fetching activities.

In some examples, it is expected that a client learns about the existence of a COPE service either directly from the access network or by other communication with a peer. When a COPE node is detected, the client can open a connection to it and request a service using, for example, MASQUE. In some examples the communication with the server is realized by an inner transport connection that is encrypted end-to-end between the client and the server. By using some or all of the above mechanisms it is possible for the Application to create a secure connection to an on-path network proxy, a secure E2E connection to the server(s) via the proxy can be established, Application data is secured E2E and protected from unauthorized used in the network and the Content provider and Mobile Network Operator have a secure channel to exchange information about application and policy real-time.

As depicted in FIG. 4, a MASQUE-based interaction starts with the application client 410 opening a QUIC tunnel connection 440 to the proxy 450 and requesting forwarding. The MASQUE/QUIC proxy provides secure forwarding but can also offer COPE services, e.g. congestion control support (mobile/satellite), access policy enforcement, load balancing/mobility, multi-hop chaining/onion routing. QUIC proxy may optionally also open a tunnel to server (if supported by server).

As such, FIG. 4 shows an inner connection 440, 460 which carries (encrypted) application traffic between client 410 and server 470 (not visible to the proxy 450), while an outer connection 420 can be used to expose information between the Content Provider (Application Client 410) and the Mobile Network Operator (e.g. QUIC Proxy at UPF 450). One issue with the current 3GPP methods to handle simultaneous connectivity at edge relocation is that different Application functionality for the different connectivity models is applied. One example is EAS re-discovery that is triggered by IP address changes for the Distributed Anchor and Multiple PDU Sessions scenarios. For Session breakout, the application client is not aware of PSA change unless explicit 3GPP-specific EAS rediscovery indication is used (as proposed in TS 23.548 V17.1.0, clause 6.2.3.3). It is unclear, however, how this reaches the application client.

Another issue is that handling UE nomadicity between 3GPP and WIFI has limitations, for example: i) the App handles IP address changes even when the Session Breakout Model is used for relocation in 3GPP networks, thus all EC-enabled applications have to be designed to support IP address changes; ii) path coexistence cannot be provided on the network level for 3GPP and WIFI accesses, which can lead to application degradation; iii) reachability of the EAS from public Internet is required, which has security implications on the local data network deployment; and iv) for E2E TCP connections, the connection cannot be migrated to the new anchor (new WIFI IP address). This means that TCP connections will fail when the IP address is changed.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. In particular, a network node may be comprised in a non-terrestrial network as part of a wireless communications system. A non-terrestrial network (NTN) comprises communications satellites and network nodes. The network nodes may be terrestrial or satellite based. For example the network node may be a satellite gateway or a satellite based base station, e.g. gNB. Other examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In particular the wireless device may be involved in communication with a non-terrestrial network nodes, such as communications satellites and satellite based gateways or base stations. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc., A wireless device may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

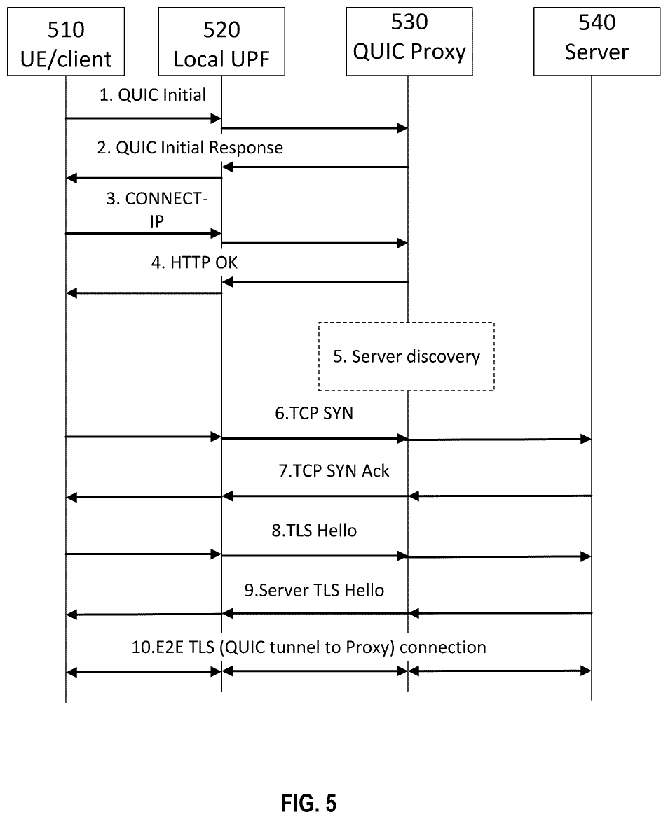

In FIG. 5 an example Connection setup to a Transmission Control Protocol/Transport Layer Security Protocol (TCP/TLS) compliant Server through a QUIC Proxy in accordance with one or more examples disclosed herein. In FIG. 5, as an example, the client 510 to the Proxy 530 is within a ‘UE’. In certain specific examples the client 510 to the Proxy 530 may reside in a 3GPP UE modem, in the UE Operating System, or in an Application Client in the UE. The procedure describes, takes for example, the QUIC handshake procedure based on TLS, see QUIC-TLS, IETF RFC 9001, as described in QUIC V1 (IETF RFC 9000). In other examples the same signalling sequence procedure may be applied used for Servers using other transport protocols. In more detail, at step 1, the client (UE) 510 sets up a QUIC connection towards the Proxy 530 by sending a “QUIC Initial” message towards the Proxy 530. The “Initial” request goes through a Local UPF 520, which is the ‘anchor’ for the client (UE) 510 towards the Proxy 530. The figure depicts an example where the end-to-end connection (from Client to the Server) is a TCP/TLS connection, and it is noted that this end-to-end connection may be any different connection (e.g., some UDP-based streaming) which would not change the procedure. In this way the QUIC “Initial” request follows the normal signalling path and thus it is not breaking the connection). TCP proxies usually intercept the TCP connection but leave the TLS end-2-end connection in tact. This split is with QUIC not possible anymore as there is no separate TLLS handshake. Thus a proxy should not intercept the QUIC connection. At step 2 the Proxy 530 responds with a “QUIC Initial Ack” response message. The Server response to the Client Initial packet may also be called “Initial” packet. It includes an Ack to the Client packet, but also other information, e.g., crypto information to establish secure connectivity It is complicated by the fact that the server message back in response to an Initial from the client contains an Initial packet with a crypto frame with the TLS Server Hello and an ACK frame, as well as Handshake packet with a crypto frame containing certificate and other things. See for example, FIG. 5 in Section 7.1 in RFC 9000:

“FIG. 5: Example 1-RTT Handshake″

```
  Client Server
  Initial[0]: CRYPTO[CH] ->
        Initial[0]: CRYPTO[SH] ACK[0]
      Handshake[0]: CRYPTO[EE, CERT, CV, FIN]
        <- 1-RTT[0]: STREAM[1, “...”]
  Initial[1]: ACK[0]
  Handshake[0]: CRYPTO[FIN], ACK[0]
  1-RTT[0]: STREAM[0, “...”], ACK[0] ->
          Handshake[1]: ACK[0]
    <- 1-RTT[1]: HANDSHAKE_DONE, STREAM[3, “...”], ACK[0]
```

In some examples, the connection to a preferred local Proxy may be achieved when the UE receives at PDU Session Establishment (or via a PDU Session Modification message after relocation) the Proxy IP address to connect to. For example, a 3GPP Non-access stratum signaling message (e.g., via Protocol Configuration Options, PCO as defined in 3GPP TS 24.301) is used to send the local Proxy address to client (UE) 510.

In another example the client (UE) 510 may receive at PDU Session Establishment an anycast IP address of the Proxy 530 and a local PSA is also established at session establishment. In this case, the client (UE) 510 request sent at Step 1 reaches the closest Proxy 530 that in turn responds with a unicast address in the “preferred address” attribute in the TLS response in Step 2 (this is described in more detail in IETF RFC 9000, section 9.6).

In another example, the UE receives at PDU Session Establishment an IP address of a central Proxy. The central Proxy triggers determination of a local Proxy close to the UE (this may also involve setting up a local PSA by the wireless communications system, e.g. 3GPP 5th Generation System, 5GS) and then responds with the IP address of the selected Proxy in the Preferred Proxy address attribute in the response sent at Step 2.

In a specific case, the client (UE) 510 moves into a new service area and relocation occurs. The client (UE) 510 receives the new Proxy IP address to connect to from the current Proxy 530. This scenario is described in more detail below.

At step 3, the client (UE) 510 sends a CONNECT-IP message to the Proxy 530 specifying the Server Uniform Resource Identifier (URI) or IP address to connect to. In some examples the CONNECT-IP message may be sent in parallel with the QUIC handshake sent at Step 1, however if a Proxy IP change happens dues to a more preferred Proxy being indicated during step 1 (as described above) then the CONNECT-IP signalling would need to be repeated. At step 4 the Proxy 530 responds with HTTP OK.

In some examples, as shown by the optional siganlling at step 5, the Proxy 530 performs additional services, e.g., discovery of the Server IP address (if only the URI was received) or discovery of the Server capabilities (e.g., TCP or QUIC) etc. For example as described in PCT/SE202I/O-51050.

At step 6, the client (UE) 510 sends a handshake message, e.g. a TCP SYN including IP header, to the Server using its own IP address. This may be sent as part of the reliable body of the QUIC packets belonging to the tunnel established at Step 3. The Proxy 530 performs address translation for this message using a Proxy address. At step 7, the Server 540 responds with a handshake response message, e.g. a TCP SYN Ack.

At step 8, the client (UE) 510 sends any additional exchange needed to establish communication, e.g. a TLS Hello message, to the Server 540 in, for example, a TCP ACK message. At step 9, the Server 540 responds with any additional responses, e.g. TLS Hello message, that is sent to the client (UE) 510 through the established QUIC tunnel. At step 10 the client (UE) 510 to Server 540 communication exchange has been established; in this example a TCP/TLS connection to the Server 540 is established via the QUIC tunnel to the Proxy.

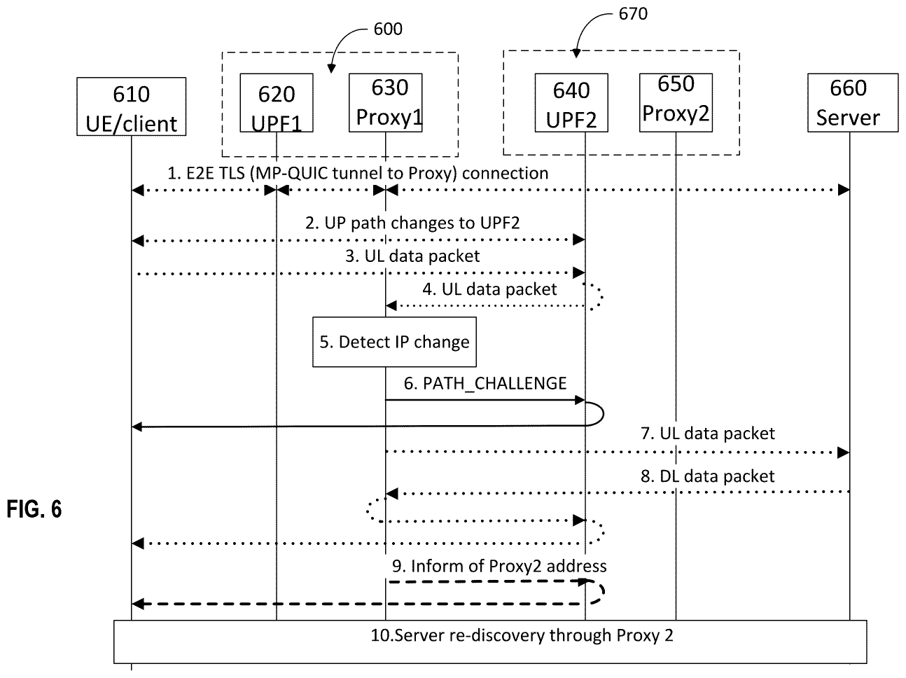

In FIG. 6 a local anchor relocation scenario is described. In this example the Session Breakout model is used for local traffic routing. It is also assumed that anchor relocation also implies Proxy relocation (in typical deployments, the UPF PSAs and Proxies are co-located, but this is not a pre-requisite for the concept). In FIG. 6 the concept of collocated UPF/Proxy is depicted by the proxy areas, Proxy Area 1 600 and Proxy Area 2 670.

The scenario assumes, at step 1, that a connection to a Server that requires Edge Connectivity is ongoing, and the user plane is tunneled through a local proxy, Proxy1 630; the connection has been previously established as described above in connection with FIG. 5. Proxy Areas are meaningful for the concept of separated Proxy and UPF, in which case one or more UPFs may belong to the same Proxy Area. The figures depict a scenario where UPF1 and UPF2 belong to different Proxy Areas, which in case of co-located Proxy is trivial. If they belonged to the same Proxy Area, then there would not be a need to change the Proxy when the UPF changes. This is regarded as a simpler solution, and not discussed further here. In the figures, generally, a continuous line is used for the signalling messages, dashed line for the optional messaging and logic and a dotted for the UP traffic. At step 2, the UP path changes to a new local PSA, UPF2. This occurs, for example, due to UE mobility. Session Breakout mechanism is used with local uplink classifier (ULCL), i.e. uplink UPF functionality that aims at diverting Uplink traffic, e.g. based on filter rules, towards UPF2, thus the UE/client 610 is unaware of the change of the local PSA. (UPF 1) 620. In the target PSA (UPF2) 640, traffic filters are established for the UL IP ranges that include Proxy1 630 towards UPF1 620. UPF2 640 is configured to change the source IP address for the traffic destined to these address ranges (e.g., by using NAT or Layer-3 tunneling). In the source UPF1 620 there are also traffic filters configured for the DL traffic towards the UE/client 610 through UPF2 640.

At step 3, the UL data packets sent on the ongoing connection from the UE/client 610 to the Server 660 through Proxy1 reach the new local anchor UPF2 640. At step 4, based on the configuration received in Step 2 UPF2 640 forwards the UL packets to Proxy 1 620 while changing the source IP address. By default, the traffic to a public Proxy address would be routed to a central UPF (the one the UE IP address relates to) and forwarded over the Internet, resulting in traffic tromboning. Another possibility that is standardized to support service continuity is that UPF2 is configured to use a (N9) tunnel to forward the UE traffic to UPF1. UPF1 would then decapsulate it and NAT/forward it to the Proxy. In this case, however, the Proxy would not notice that the UE has moved to another local anchor. At step 5 Proxy1 620 detects the IP change of the UL packets belonging to this QUIC connection. Proxy 1 620 then, at step 6, triggers, for example, a standard QUIC PATH-CHALLENGE message to the UE/client 610 to validate the new path; this message is routed (forwarded) through UPF2 640 to the UE/client 610. For example, as described in IETF RFC 9000 section 8.2: “Path validation is used by both peers during connection migration (see Section 9) to verify reachability after a change of address. In path validation, endpoints test reachability between a specific local address and a specific peer address, where an address is the 2-tuple of IP address and port.

Path validation tests that packets sent on a path to a peer are received by that peer. Path validation is used to ensure that packets received from a migrating peer do not carry a spoofed source address.

Path validation does not validate that a peer can send in the return direction. Acknowledgments cannot be used for return path validation because they contain insufficient entropy and might be spoofed. Endpoints independently determine reachability on each direction of a path, and therefore return reachability can only be established by the peer. Path validation can be used at any time by either endpoint . . . ”

The UE may initiate path validation triggered by UPF relocation, when it receives a new IP address. Otherwise, it should be initiated by the Proxy.

In some examples Proxy1 630 may include a new extension, e.g. a QUIC frame, in PATH_CHALLENGE that provides reachability information for a new proxy local to UPF2 640. The reachability information such as identity and location e.g., the host name to validate in any certificate and the IP address for the new Proxy to tunnel the UE/client 610 traffic from the new location more efficiently.

The following is an example extension to the PATH_CHALLENGE Frame:

### PATH_CHALLENGE_REDIRECT Frames

Endpoints can use PATH_CHALLENGE_REDIRECT frames to check reachability to the peer and for path validation during connection migration and at the same time provide information to redirect the client to a new server that might be more optimal with the new path.

PATH_CHALLENGE_REDIRECT frames are formatted as shown below:

PATH_CHALLENGE Frame {
Type (i) = TBD,
IP(i)
Host(i),
Data (64)}

PATH_CHALLENGE_REDIRECT frames contain the following field:
IP: IP address of new proxy
Host: host name of new proxy
Data: This 8-byte field contains arbitrary data.

Including 64 bits of entropy in a PATH_CHALLENGE frame ensures that it is easier to receive the packet than it is to guess the value correctly.

In the above is an example that would replace the PATH_CHALLENGE frame, however, an alternative could be to define a new separate frame that is then sent together with the PATH_CHALLENGE frame in the same QUIC packet.

In other examples the message may include the IP address ‘seen’ by the Proxy 1, which may be also used by the UE/client 610 to infer the reachability of Proxy2 650. This approach may be beneficial for other use cases as well. This requires some signaling from the QUIC stack to the application layer on the UE 610 end to convey this information.

At step 7, UL traffic (data packet) is forwarded from Proxy1 630 to Server 660 using the same outfacing IP address from Proxy 1 630 as before, thus Server 660 is completely agnostic/unaware of the UP path change. At step 8 DL traffic (data packet) is transmitted by the Server 760, the path followed by the DL traffic (data packet) corresponds to that of the UL traffic (data packet).

In some examples Proxy1 630 may explicitly inform the UE/client 610 about the new IP address for Proxy2 650 to use for its new connections, shown by step 9. This could be an alternative to the new extension in the PATH_CHALLENGE message in Step 6 and may be achieved via a new MASQUE message. This is similar to what is proposed in the IETF draft multipath extension for QUIC (MP-QUIC) (https://datatracker.ietf.org/doc/draft-liu-multipath-quic/) for adding a new sub-connection via the PATH_CHALLENGE message, but the proposal here would be performed on the MASQUE layer with the purpose to trigger application-layer change of the Proxy to connect to. In such examples additional signaling from the MASQUE stack to the application layer on the UE 610 end is introduced. MASQUE extension mechanism are not fully specified yet, so specific examples of how this might be achieved are dependent on how the extension mechanism would be defined. E.g. this could be based on a HTTP REQUEST/REPLY containing some JSON config file. In another example a new CAPSULE type could be defined. The capsule protocol is specified in the HTTP datagram specification, and can be used to exchange data between two MASQUE peers.

At step 10, the UE/client 610 starts Server discovery as discussed previously, ensuring that the discovery goes through Proxy2 650 based on its internal trigger or as result of the notification it receives by steps 6 or 9 of FIG. 6, as described above. In some examples one of the following mechanisms may be used:

I. Proxy2 650 reachability information is received by the UE/client 610 in an extension of the PATH_CHALLENGE message, as described in Step 6 above.

=Proxy2 650 reachability information is received by the UE/client 610 via explicit signaling mechanisms from Proxy1 630, as discussed in Step 9 above.

III. No explicit information about the new Proxy is received by the UE/client 610, the UE establishes the connectivity to Proxy2 650 by performing a new connection establishment to a Proxy anycast address or to a Proxy central IP address, as described in relation to Step 2 of the description for FIG. 5.

When one of the above alternatives has been successfully used to establish a new proxy connection, the UE/client 610 can starts Server discovery through the new proxy connection.

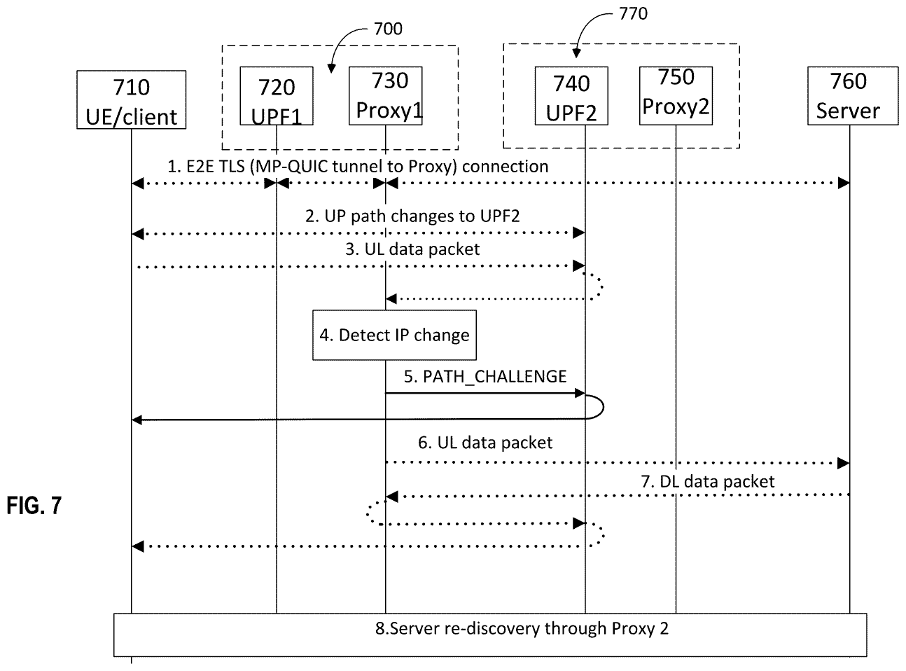

In FIG. 7 re-location for Distributed Anchor or WIFI nomadicity is described, wherein a local anchor relocation occurs; the UE receives a new IP address when configuring the new local anchor. This happens at Distributed anchor connectivity model, or when the UE migrates to a WIFI access. In FIG. 7 the UPF and Proxy are depicted by the proxy areas, Proxy Area 1 700 and Proxy Area 2 670. As noted previously proxy areas are meaningful for the concept of separated Proxy and UPF, in which case one or more UPFs may belong to the same Proxy Area. The figures depict a scenario where UPF1 and UPF2 belong to different Proxy Areas, which in case of co-located Proxy is trivial. If they belonged to the same Proxy Area, then there would not be a need to change the Proxy when the UPF changes. The signalling sequence of FIG. 7 assumes at step 1 that a connection between a UE/client 710 and a Server 760 has been established and that ongoing Edge Communication is required. The UP connection is tunneled through a local proxy, Proxy1 730. The connection may be assumed to have been established as described for FIG. 5. In this case the UE is aware of anchor change as it receives a new IP address from UPF2. Thus, there is no need for any UPF2 IP re-write functionality and there is also no need to notify the UE about the anchor change that may trigger a new proxy discovery.

At step 2, the UP path changes to a new local PSA, UPF2 740 and the UE/client 710 receives a new IP address for the PSA (UPF 2), this is the UE (source) IP address that is updated UPF2 works as local gateway. The UP path change occurs, for example due to UE mobility. At step 3 the UE/client switches to the new IP address received and sends UL packets towards Proxy1 730. Since the UE/client 710 may be accessing through a public WIFI access, this requires that a) Proxy1 730 should be globally reachable, i.e., it should have a publicly reachable IP address. Note that the QUIC tunnel guarantees secure connectivity to Proxy1 730; and b) Non-3GPP Inter-Working Function (N3IWF) functionality could be also used to provide secure connectivity to the UPF2 740 in the Core Network and then to Proxy1 730.

At step 4, Proxy1 730 detects IP change of the UL packets belonging to this QUIC connection. This triggers a standard QUIC PATH_CHALLENGE message to the UE/client 710 from Proxy1 730 at step 5 to validate the new path (forwarded through UPF2 740). In some examples Proxy1 730 may include a new extension frame in PATH_CHALLENGE that provides reachability (e.g., the IP address) for the new Proxy (i.e., Proxy2 750) that may be used to tunnel UE traffic (data packets) from the new location.

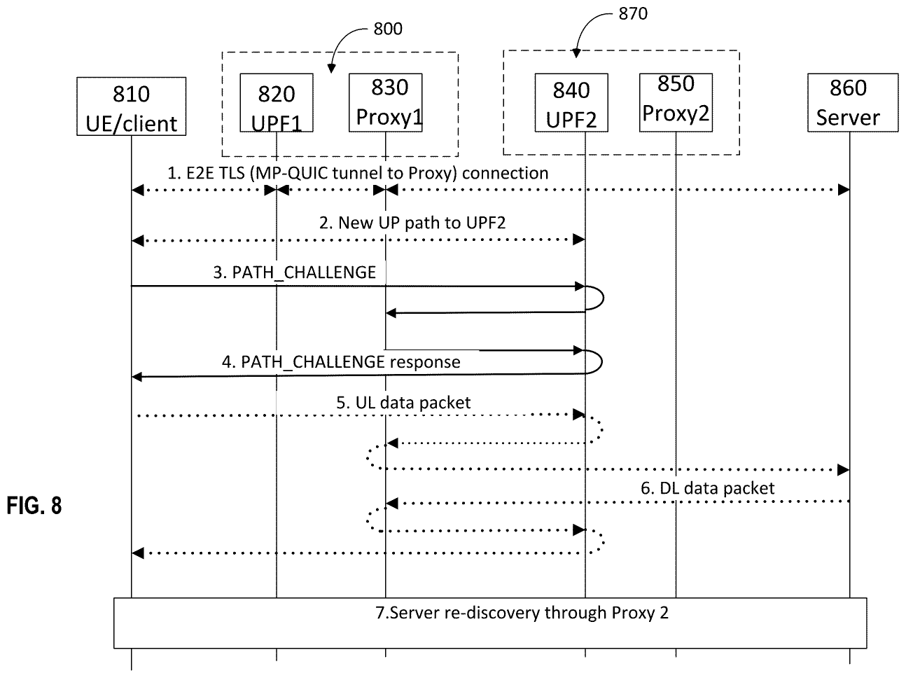

In some examples, as an alternative to Steps 4 and 5, the UE directly triggers a path validation message to the Proxy1 730 that responds with the reachability of Proxy2 750, similarly as described in Steps 3-4 of FIG. 8. This provides the same functionality as FIG. 6, and it is optional in both cases, if the UE can discover the Proxy by itself (e.g., via DNS resolution)

At step 6, UL traffic (data packet) is forwarded from Proxy1 to Server using the same outfacing IP address from Proxy 1 as before, thus Server is completely agnostic of the UP path change At step 7, DL traffic (data packet) is transmitted by the Server 760, the path followed by the data packet corresponds to that of the UL traffic in reverse direction.

At step 8, the UE/client 710 starts Server discovery through Proxy2 750, using Proxy2 750 reachability received in Step 4 or discovering Proxy2 as discussed for FIG. 5 (steps 2b or 2c). Note: The server discovery procedure is described in FIG. 5 Step 2a-d, but the relevant parts are here 2b and 2c since 2a applies only for PDU session setup and 2d is when proxy reachability is received, in Step 4 abovel. n the latter case, this step may be started in parallel with Step 3.

In relation to FIG. 8 re-location for a Multi-homed UE/client is described. FIG. 8 shows the re-location procedure in the case when multiple IP addresses are provided to the UE for session continuity, i.e., one of the following scenarios:

SSC Mode 3 with Multiple Sessions, where the UE establishes a new PDU session with UPF2 840 as IP anchor (PSA);

SSC Mode 3 with IPV6 multi-homing, where the UE receives new IP address via route advertisement) that is routed towards UPF2 840; and

Moving to WIFI access from cellular (or vice versa) where the UE keeps the connection (and IP address) also in the original access.

In at least some of the examples described simultaneous utilization of both accesses in the ongoing connection even for a non-multipath capable Server, via a transport multipath to Proxy is enabled. In FIG. 8 the UPF and Proxy are depicted by the proxy areas, Proxy Area 1 800 and Proxy Area 2 870. As noted previously proxy areas are meaningful for the concept of separated Proxy and UPF, in which case one or more UPFs may belong to the same Proxy Area. The figures depict a scenario where UPF1 and UPF2 belong to different Proxy Areas, which in case of co-located Proxy is trivial. If they belonged to the same Proxy Area, then there would not be a need to change the Proxy when the UPF changes. In the disclosure, the term user plane proxy function refers primarily to the proxy handling the one or more UPFs within a Proxy Area. The procedure is described in more detail, referring to FIG. 8, wherein at step 1 a connection to a Server that requires Edge Connectivity is ongoing, and the UP is tunnelled through a local proxy, Proxy1 830; the connection has been previously established as described in relation to FIG. 5, above.

At step 2, the UP path changes or receives an additional parallel connection to a new local PSA, UPF2 840 and the UE/client 810 receives a new IP address. In this case the multi-homed UE receives a new IP address anchored at UPF2, so this results in an additional access. At step 3, the UE/client 810 issues a PATH-CHALLENGE message that in this case initiates the establishment of a new QUIC sub-connection according to the present Multi-path QUIC drafts. Practically this message links the UL packet (with the new source IP address received fromtUPF2) to the MP QUIC connection, by which Proxy 1 learns that there is a new sub-connection available for that MP connection At step 4 Proxy1 830 responds to the PATH-CHALLENGE. In some examples the Proxy 1 includes a new extension frame in PATH_CHALLENGE that provides reachability (e.g., the IP address) for the new Proxy (i.e., Proxy2 850) that may be used to tunnel UE/client 810 traffic (data packets) from the new (UPF2) location.

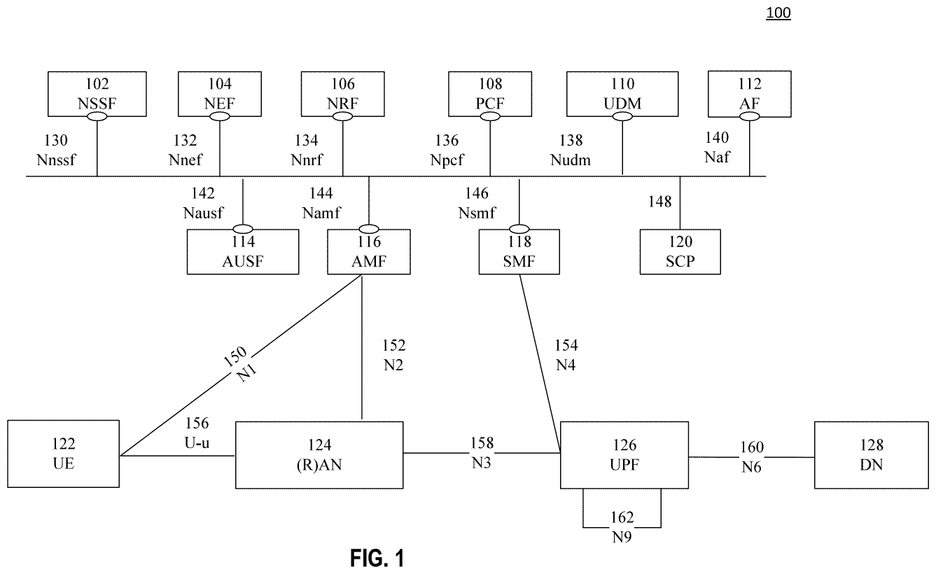

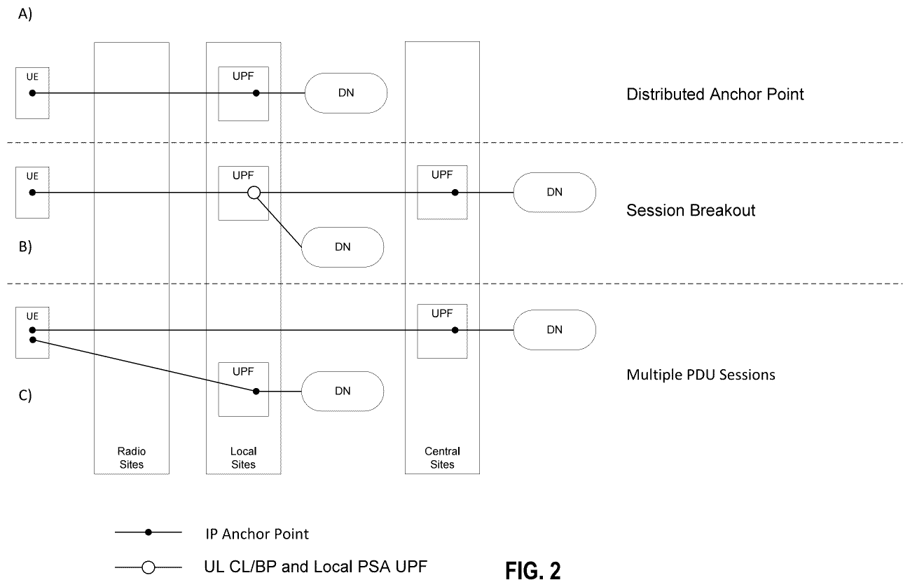

At step 5 the UL traffic (data packets) of the new sub-connection goes through UPF2 840 to Proxy1 830 and then forwarded to the server 870 (Note: the original UP path shown in Step 1 is also active). At step 6, the DL traffic (data packets) path corresponds to that of the UL traffic (data packets) in reverse direction. At step 7 the UE/client 810 starts Server discovery through Proxy2 850, using Proxy2 850 reachability as discussed above or discovering Proxy2 850 as discussed in relation to FIG. 1. In the latter case, this step may be started in parallel with Step 3.

Example embodiments will now be described in more detail in relation to the corresponding figures.

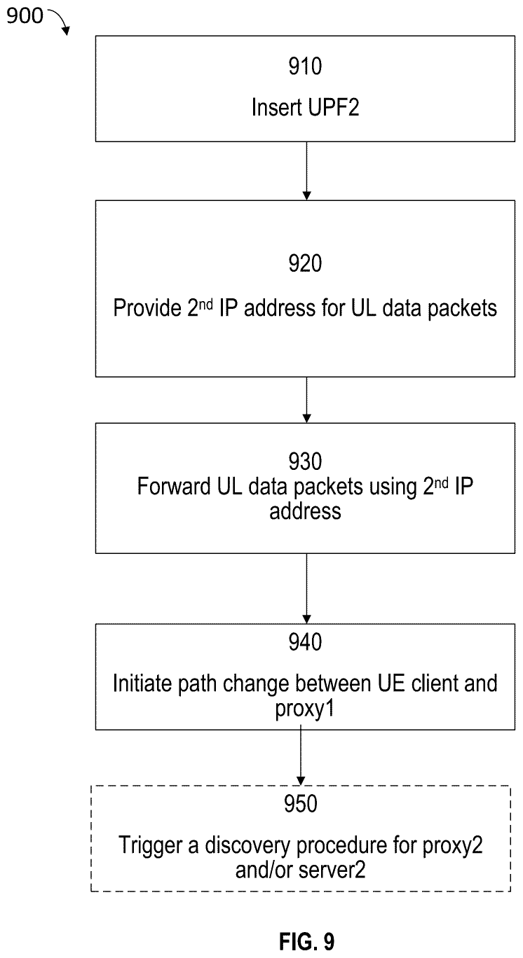

In FIG. 9 a flow chart is depicted for a method 900 in a wireless communication system. The method is applied for service continuity between a user equipment, UE, based client application and a server. In some examples the connection comprises an edge application server. In some examples the connection further comprises a first local user plane function and a first proxy function. As previously described the proxy function and user plane function (UPF) may be independent logical and/or physical entities. In other examples the proxy function and the UPF may be a common logical and/or physical entity. For convenience the two functions may be described singularly as a ‘proxy and user plane function’, even when two separate functions are implemented.

In some examples a user plane tunnel connection exists between the UE based client and the first proxy and user plane function, the user plane tunnel connection may comprise a first source internet protocol, IP, address. In FIG. 9, the method 900 begins with the step of inserting 910 a second user plane function, e.g. UPF2, between the UE based client and the server. This step 910 may be the result of mobility by the UE, e.g. handover, cell change etc. In some examples this may be the result of a network management, core network and/or radio network resource management action.

The UP path changes to a new local PSA, UPF2. In some examples a Session Breakout mechanism is used with local UL classifier (ULCL) towards UPF2. In some examples the UE is agnostic to or unaware of the change of the local PSA. In the target PSA, i.e., UPF2 traffic filters are established for the UL IP ranges that include Proxy1 towards UPF1.

In some examples the UPF2 is inserted as a result of a local anchor relocation scenario when the UE receives a new IP address when configuring the new local anchor. This happens at Distributed anchor connectivity model, or when the UE migrates to a WIFI access.

In some examples the UPF2 is inserted as a result of multi-homing. For example, in accordance with an SSC Mode 3 with Multiple Sessions, where the UE establishes a new PDU session with UPF2 as IP anchor (PSA). In another example, in accordance with an SSC Mode 3 with IPV6 multi-homing, where the UE receives new IP address via route advertisement) that is routed towards UPF2. In yet another example, in accordance with the UE moving to WIFI access from cellular (or vice versa) where the UE keeps the connection (and IP address) also in the original access. In such examples simultaneous utilization of both accesses in the ongoing connection (even for a non-multipath capable Server) via transport multipath to Proxy may be achieved.

The method proceeds with providing 920 a second source IP address for UL data packets to the UPF2, wherein the second source IP is different from the first IP address. In some examples UPF2 is provided with the second source IP address during the configuration of the new local PSA. In other examples the second source IP address is provided by the UE.

The method proceeds with forwarding 930 UL data packets from the second user plane function to the first user plane proxy function, wherein the first IP address is replaced with the second IP address. In some examples UPF2 is configured to change the source IP address for the traffic destined to the address ranges for the UL IP ranges that include Proxy1 towards UPF1 (e.g., by using NAT or Layer-3 tunneling). In the source UPF1 there are also traffic filters configured for the DL traffic towards the UE through UPF2. In other examples the UL data packets are transmitted by the UE with the first source IP address changed for the second source IP address.

The method proceeds with initiating 940 a path change procedure between the UE based client and the first proxy. In some examples the path change procedure is initiated by the first proxy in response to detecting the change to the second source IP address. In other examples the path change procedure is initiated by the UE based client. For example, when the UE based client receives the new IP address as part of a distributed anchor procedure or is configured with the new IP address as part of a multi-homing scenario. In some examples the UE based client triggers a path validation directly (e.g. QUIC PATH_CHALLENGE) to the first proxy (proxy1) and receives the “reachability” information (e.g. IP address) in response (e.g. PATH_RESPONSE). In some examples the path change procedure comprises including reachability information for the second proxy in an extended or adapted Quick UDP Internet Connection, QUIC, protocol PATH_CHALLENGE message which is performed to validate the new path (forwarded through UPF2). For example, in the multi-homing scenario, the UE issues a PATH-CHALLENGE message that in this case initiates the establishment of a new QUIC sub-connection according to the present Multi-path QUIC drafts. Proxy1 responds to the PATH-CHALLENGE and includes a new extension frame in PATH_RESPONSE that provides reachability (e.g., the IP address) for the new Proxy (i.e., Proxy2) that may be used to tunnel UE traffic from the new location.

In some examples the path change procedure comprises a separate message indicating to the UE based client an IP address for the second proxy. For example, this message is sent independently from the QUIC protocol PATH_CHALLENGE which is performed to validate the new path. In some examples the message comprises a multiplexed application substrate over QUIC encryption, MASQUE, message. In other words, the first proxy explicitly informs the UE about the second proxy (Proxy2) IP address to use for its new connections. This may be an alternative to an extension in the PATH_CHALLENGE message described above. This is similar to what is proposed in the MP-QUIC draft for adding a new sub-connection via the PATH_CHALLENGE message but is, instead, conveyed on the MASQUE layer with the purpose to trigger application-layer change of the Proxy to connect to. This needs some signaling from the MASQUE stack to the application layer at the UE.

In other examples the message may be part of another QUIC procedure, the message may include the IP address ‘seen’ by the Proxy, which may be also used by the UE to infer the reachability of Proxy2 but it may be beneficial for other use cases as well. This may require signaling from the QUIC stack to the application layer on the UE end to convey this information.

In some examples the reachability information comprises one or more of: an identity; FQDN; security credentials; a location or positioning information; a host name; an IP address.

In some examples the method optionally includes the step of triggering 950 a discovery procedure to enable the connection of a second proxy associated with the second user plane function. In some examples the triggering 950 comprises providing reachability information for the second proxy local to the second user plane function. In some examples as a result of the discovery, a tunnel connection is established between the UE based client and the second proxy wherein UL data packets are routed from the second proxy to the server and bypassing the first proxy. In some examples the triggering 950 further includes triggering a server discovery procedure through the established tunnel connection.

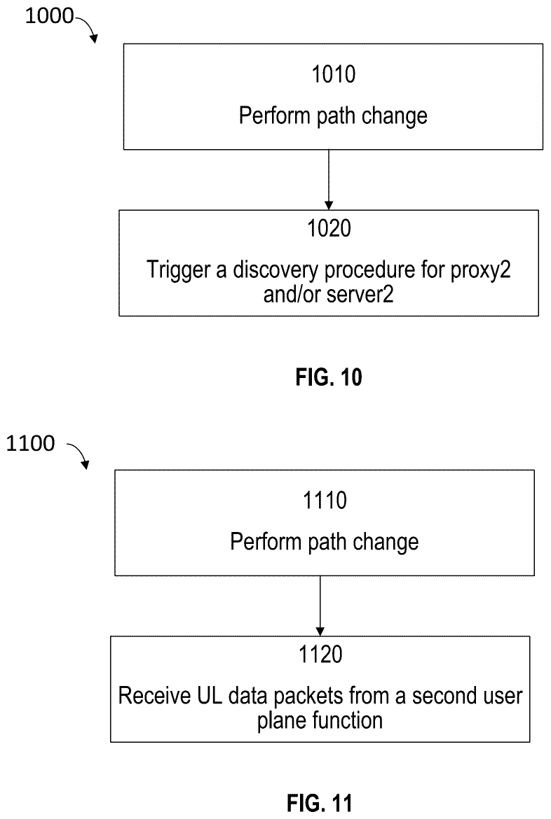

In FIG. 10, a flowchart is depicted for a method 1000 performed by a user equipment, UE, in a wireless communication system. The UE comprises a client application and the method 1000 is for service continuity between the client application of the UE and a server, for example an edge application server. In some examples the connection further comprises a first local user plane function and a first proxy and a user plane tunnel connection between the UE based client and the first proxy and user plane function, the user plane tunnel connection further comprising a first source internet protocol, IP, address. For convenience the two functions may be described singularly as a ‘proxy and user plane function’, even when two separate functions are implemented.

The method 1000 begins with the step of performing 1010 a path change procedure in response to a connection being established to a second user plane function (UPF2). In some examples the second user plane function is configured to forward UL packets to the first proxy function with a second source IP address, different to the first source IP address. In other examples the UE obtains the second IP address and forwards UL packets to second user plane function with the first source IP address changed to the second source IP address.

In some examples the path change procedure comprises receiving a message from the first proxy in response to the first proxy detecting the change to the second source IP address. In other examples the path change procedure is initiated by the UE based client. For example, when the UE based client receives the new IP address as part of a distributed anchor procedure or is configured with the new IP address as part of a multi-homing scenario. In some examples the UE based client triggers a path validation directly (e.g. QUIC PATH_CHALLENGE) to the first proxy (proxy1) and receives the “reachability” information (e.g. IP address) in response (e.g. PATH_RESPONSE). In some examples the path change procedure comprises the UE based client receiving reachability information for the second proxy in an extended or adapted Quick UDP Internet Connection, QUIC, protocol

PATH_CHALLENGE message which is performed to validate the new path (forwarded through UPF2). For example, in the multi-homing scenario, the UE issues a PATH-CHALLENGE message that in this case initiates the establishment of a new QUIC sub-connection according to the present Multi-path QUIC drafts. Proxy1 responds to the PATH-CHALLENGE and includes a new extension frame in PATH_RESPONSE that provides reachability (e.g., the IP address) for the new Proxy (i.e., Proxy2) that may be used to tunnel UE traffic from the new location.

In some examples the path change procedure comprises a separate message received by the UE based client indicating to the UE based client an IP address for the second proxy. For example, this message is sent independently from the QUIC protocol PATH_CHALLENGE which is performed to validate the new path. In some examples the message comprises a multiplexed application substrate over QUIC encryption, MASQUE, message. In other words, the first proxy explicitly informs the UE about the second proxy (Proxy2) IP address to use for its new connections. This may be an alternative to an extension in the PATH_CHALLENGE message described above. This is similar to what is proposed in the MP-QUIC draft for adding a new sub-connection via the PATH_CHALLENGE message but is, instead, conveyed on the MASQUE layer with the purpose to trigger application-layer change of the Proxy to connect to. This needs some signaling from the MASQUE stack to the application layer at the UE.

In other examples the message may be part of another QUIC procedure, the message may include the IP address ‘seen’ by the Proxy, which may be also used by the UE to infer the reachability of Proxy2 but it may be beneficial for other use cases as well. This may require signaling from the QUIC stack to the application layer on the UE end to convey this information.

In some examples the reachability information comprises one or more of: an identity; FQDN; security credentials; a location or positioning information; a host name; an IP address.

The method 1000 proceeds with the step of triggering 1020 a discovery procedure to enable the connection of a second proxy associated with the second user plane function, based on the path change procedure. In some examples the triggering 1020 comprises providing reachability information for the second proxy local to the second user plane function. In some examples as a result of the discovery, a tunnel connection is established between the UE based client and the second proxy wherein UL data packets are routed from the second proxy to the server and bypassing the first proxy. In some examples the triggering 1020 further includes triggering a server discovery procedure through the established tunnel connection.

In some examples the UE based client ensures that the discovery goes through Proxy2 based on its internal trigger or as result of the path change procedure. In some examples one of the following mechanisms is used: proxy2 reachability information is received in an extension of the PATH_CHALLENGE message, as described above; proxy2 reachability information is received via explicit signaling mechanisms from Proxy1, as discussed above and If no explicit information about the new Proxy is received, then UE establishes the connectivity to Proxy2 by performing a new connection establishment to a Proxy anycast address or to a Proxy central IP address, as described previously. When one of the alternatives has been successfully used to establish a new proxy connection, the UE starts Server discovery through the new proxy connection.

In some examples the reachability information comprises one or more of: an identity; FQDN; security credentials; a location or positioning information; a host name; an IP address.

In FIG. 11 a method 1100 performed by a first proxy function, in a wireless communication system is described. The method being for service continuity between a UE-based client application and a server, for example an edge application server. In some examples the connection further comprises a first local user plane function associated with the first proxy function and a user plane tunnel connection between the UE based client and the first proxy and user plane function. In some examples the user plane tunnel connection further comprises a first source internet protocol, IP, address. For convenience the two functions may be described singularly as a ‘proxy and user plane function’, even when two separate functions are implemented.

The method 1100 begins with the step of performing 1110 a path change procedure in response to a connection being established to a second user plane function. In some examples the path change procedure is initiated by the first proxy function as a result of the second user plane function being configured to forward UL packets to the first proxy function with a second source IP address, different to the first source IP address. In other examples the first proxy function receives a message initiating the path change procedure from the UE based client. In some examples the path change procedure comprises providing to the UE based client reachability information for a second proxy local to the second user plane function. In some examples the reachability information comprises one or more of: an identity; a location or positioning information; a host name; an IP address. In some examples the path change procedure comprises sending a Quick UDP Internet Connection, QUIC, protocol PATH_CHALLENGE message, for example when the first proxy function initiates the procedure. In other examples the path change procedure comprises the first proxy function sending a Quick UDP Internet Connection, QUIC, protocol PATH_RESPONSE message, in response to a PATH_CHALLENGE message received from the UE based client. In some examples the path change procedure comprises the first proxy function sending a message comprising an IP address for the second proxy to the UE based client. In some examples the message comprises a multiplexed application substrate over QUIC encryption, MASQUE, message.

The method 1100 proceeds with the step of receiving 1120 UL data packets from the second user plane function. In some examples, as described above the receiving 1120 triggers the first proxy function to perform 1110 the path change procedure by detecting the change of IP address. In which case the receiving 1120 UL data packets from the second user plane function also occurs before the path change procedure is performed. In other examples, e.g. for multi-homed UE, the path change procedure is initiated by the UE based client before the UL data packets are received from the second user plane function and the first proxy function is not required to detect the change of IP address.

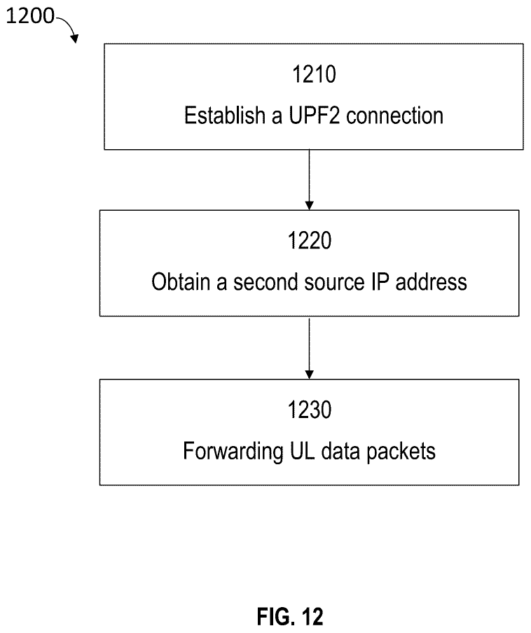

In FIG. 12, a method 1200 performed by a second proxy function in a wireless communication system is described. The method is for service continuity between a UE-based client application and a server, for example an edge application server. In some examples the connection further comprises a first local user plane function associated with a first proxy function and a user plane tunnel connection between the UE based client and the first proxy and user plane function. In some examples the user plane tunnel connection further comprises a first source internet protocol, IP, address. For convenience the two functions may be described singularly as a ‘proxy and user plane function’, even when two separate functions are implemented.

The method 1200 begins with the step of establishing 1210 a second user plane function connection between the UE based client and the first user plane connection. The method proceeds with the step of obtaining 1220 a second source IP address for UL data packets, wherein the second source IP is different from the first IP address. In some examples the second IP address is obtained through configuration when a new local PSA connection is established. In other examples the second source IP address is obtained from the UE based client.

The method proceeds with the step of forwarding 1230 UL data packets from the second user plane function to the first user plane proxy function, wherein the first IP address is replaced with the second IP address. In some examples the second user plane function is configured to exchange the source IP address when receiving from the UE based client before forwarding to the first proxy and user plane function. In other examples the second user plane function receives the UL data packets with the second source IP address from the UE based client, e.g. the IP address is changed by the UE based client.

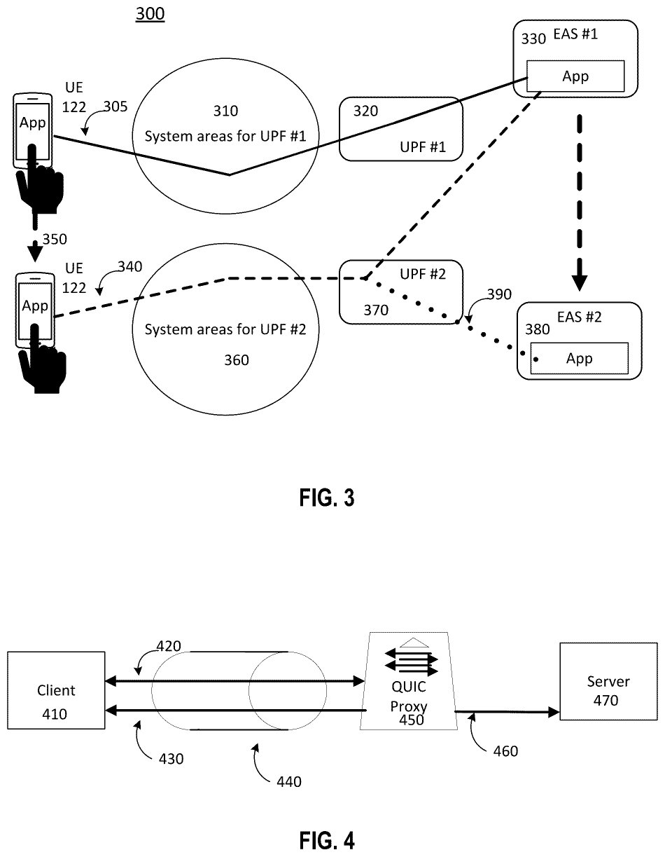

In some examples a wireless communication system such as 300 depicted in FIG. 3 comprises a user equipment, UE, based client application such as 122 depicted in FIG. 3, an edge application server, such as 330 in FIG. 3, a first local user plane function such as 320 in FIG. 3 and a first proxy, which may be collocated with the first UPF 320. The system includes a user plane tunnel connection 305 between the UE based client application and the first proxy and user plane function 320, the user plane tunnel connection further comprising a first source internet protocol, IP, address. In some examples the system 300 is configured to insert a second user plane function 370 between the UE based client 122 and the server 330. The system 300 may be further configured to provide a second source IP address for UL data packets, wherein the second source IP is different from the first IP address. The system 300 is further configured to forward UL data packets from the second user plane function 370 to the first user plane proxy function 320, wherein the first IP address is replaced with the second IP address. The system 300 may be further configure to initiate a path change procedure between the UE based client 122 and the first proxy 320 in response to detecting the change to the second source IP address.

The system described may be further configured to perform any of the previously described embodiments, for example triggering discovery procedures to enable the UE based application client to establish a tunnel connection to the second user plane function and perform discovery procedures to discover a second server 380, which may be more local to the second user plane function.

In some examples a user equipment (UE) is provided comprising a client application wherein the client application is connected to a server, the connection comprising an edge application server and the connection further comprising a first local user plane function and a first proxy and a user plane tunnel connection between the UE based client and a first proxy and user plane function, the user plane tunnel connection further comprising a first source internet protocol, IP, address. The UE is configured to perform a path change procedure in response to a connection being established to a second user plane function configured to forward UL packets to the first proxy function with a second source IP address, different to the first source IP address. The UE is further configured to trigger a discovery procedure to enable the connection of a second proxy associated with the second user plane function, based on the path change procedure.

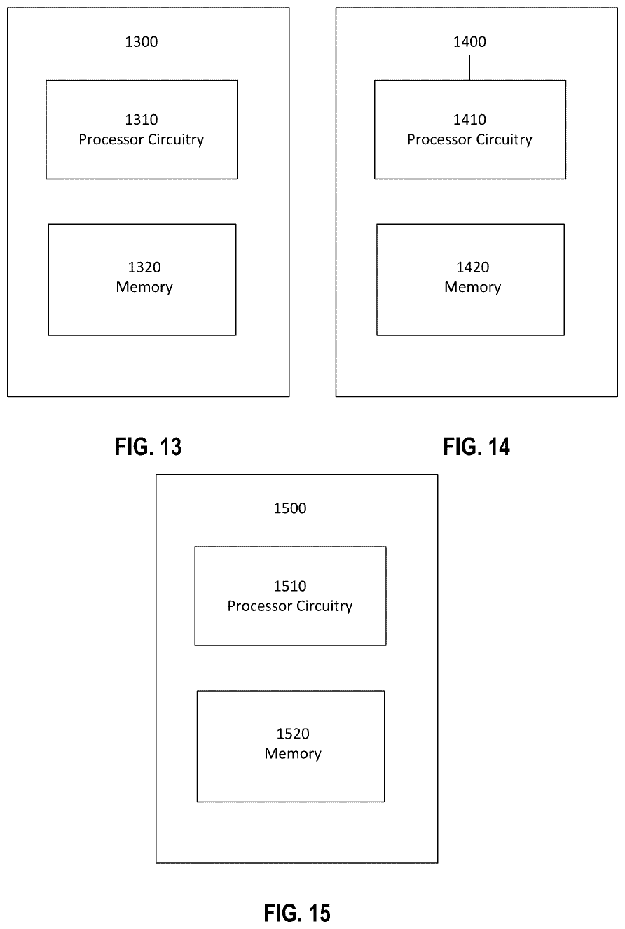

In some examples, as depicted in FIG. 13, the UE comprises processor circuitry 1310 and memory 1320. The user equipment, UE, comprising a client application which is stored in the memory 1320 and executed on the processor circuitry 1310, wherein the client application may be connected to a server, the connection comprising an edge application server and the connection further comprising a first local user plane function and a first proxy and a user plane tunnel connection between the UE based client and a first proxy and user plane function, the user plane tunnel connection further comprising a first source internet protocol, IP, address. The processor circuitry 1310 is configured to obtain instructions from the memory 1320 which when executed cause the processor to perform a path change procedure in response to a connection being established to a second user plane function configured to forward UL packets to the first proxy function with a second source IP address, different to the first source IP address; and trigger a discovery procedure to enable the connection of a second proxy associated with the second user plane function, based on the path change procedure.

The UE and/or processor circuitry may be further configured to perform any of embodiments disclosed herein pertaining to a UE.

In some examples a first proxy function, in a wireless communication system for service continuity between a UE-based client application and a server is provided. The connection comprising an edge application server and the connection further comprising a first local user plane function associated with the first proxy function and a user plane tunnel connection between a UE based client and the first proxy and user plane function, the user plane tunnel connection further comprising a first source internet protocol, IP, address. The first proxy function is configured to perform a path change procedure in response to a connection being established to a second user plane function configured to forward UL packets to the first proxy function with a second source IP address, different to the first source IP address.

In some examples, as depicted in FIG. 14, the first proxy function comprises processor circuitry 1410 and memory 1420. The process circuitry 1410 is configured to obtain instructions from the memory 1420, which when executed by the processor circuitry cause the processor circuitry to perform a path change procedure in response to a connection being established to a second user plane function configured to forward UL packets to the first proxy function with a second source IP address, different to the first source IP address.

In some examples a second proxy function in a wireless communication system for service continuity between a UE-based client application and a server is provided. The connection comprising an edge application server and the connection further comprising a first local user plane function associated with a first proxy function and a user plane tunnel connection between a UE based client and the first proxy and user plane function, the user plane tunnel connection further comprising a first source internet protocol, IP, address. The second proxy function is configured to establish a second user plane function connection between the UE based client and the first user plane connection. The second proxy function is further configured to obtain a second source IP address for UL data packets, wherein the second source IP is different from the first IP address. Furthermore, the second proxy function is configured to forward UL data packets from the second user plane function to the first user plane proxy function, wherein the first IP address is replaced with the second IP address.

In some examples, as depicted in FIG. 15, the second proxy function comprises processor circuitry 1510 and memory 1520. The processor circuitry is configured to obtain instructions stored in the memory 1520, which when executed by the processor circuitry, cause the processor circuitry to establish a second user plane function connection between the UE based client and the first user plane connection, obtain a second source IP address for UL data packets, wherein the second source IP is different from the first IP address and forward UL data packets from the second user plane function to the first user plane proxy function, wherein the first IP address is replaced with the second IP address.

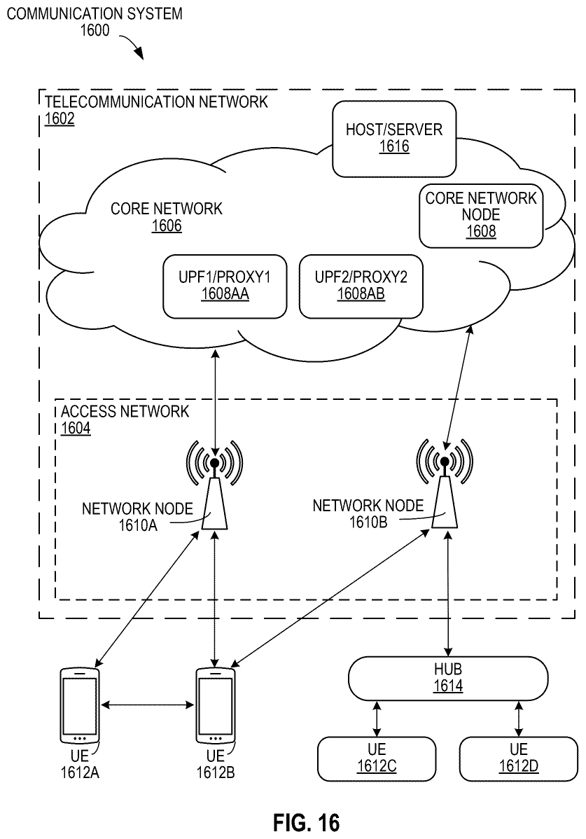

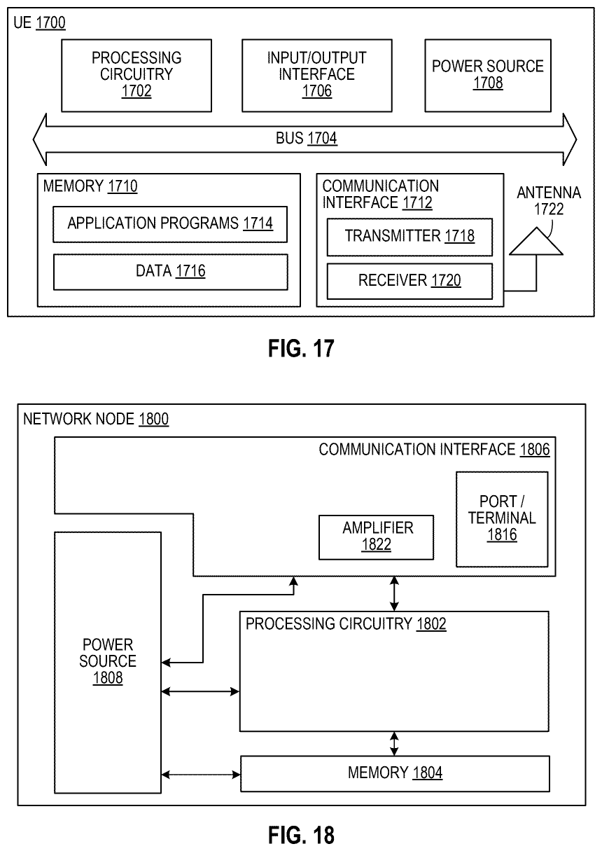

A user equipment, UE, comprising a client application as depicted by 122 in FIG. 3 may be configured to perform one or more embodiments as described herein. Such a UE may comprise various structural elements, such as those depicted in FIG. 17. The UE functionality is described in more detail with respect to FIG. 17 below. In some examples the client application is connected to a server such as 330 in FIG. 3 or 1616 in FIG. 16. The connection comprising an edge application server and the connection further comprising a first local user plane function such as 320 in FIG. 3 or 1608AA in FIG. 16. In the figures the first proxy function is depicted as being collocated with the first UPF but as described previously this is for convenience and in some examples the entities may be separate. A user plane tunnel connection is established between the UE based client and a first proxy and user plane function 320, 1608AA. The user plane tunnel connection further comprises a first source internet protocol, IP, address, i.e. the address used for routing the UL data packets to the first proxy function. The UE 122, 1612, is configured to perform a path change procedure in response to a connection being established to a second user plane function, for example 370 in FIG. 3, or 1608AB in FIG. 16. The second UPF 370, 1608AB being configured to forward UL packets to the first proxy function 320, 1608AA with a second source IP address, different to the first source IP address. The UE 122, 1612 is further configured to trigger a discovery procedure to enable the connection of a second proxy associated with the second user plane function, based on the path change procedure. The specific examples of this procedure are described in more detail above. As such, in some examples the UE 122, 1612, is further configured to perform any of the embodiments corresponding to the UE, described herein.

A first proxy function, for example as depicted by 320 in FIG. 3 or 1608AA in FIG. 16 may be configured to perform a number of embodiments described herein. The proxy function 320, 1608AA is arranged in a wireless communication system 300, 1600 to provide, among other tasks, service continuity between a UE-based client application 122, 1612 and a server 330, 1616. The connection comprises an edge application server 330 and the connection further comprising a first local user plane function 320, 1608AA associated with the first proxy function and a user plane tunnel connection between a UE based client 122 1612 and the first proxy and user plane function 320, 1608AA. The user plane tunnel connection comprises a first source internet protocol, IP, address. In some examples the first proxy function 320, 1608AA is configured to perform a path change procedure after a connection to a second user plane function has been established. In some examples the second user plane function is configured to forward UL packets to the first proxy function 320, 1608AA with a second source IP address, different to the first source IP address. As described previously, in other examples the first proxy function 320, 1608AA is further configured to perform any embodiments described herein which pertain to a first proxy and user plane function.

A second proxy function, for example as depicted by 370 in FIG. 3 or 1608AB in FIG. 16 may be configured to perform a number of embodiments described herein. The second proxy function 370, 1608AB is arranged in a wireless communication system 300, 1600 to provide, among other tasks, service continuity between a UE-based client application 122, 1612 and a server 330, 1616. The connection comprises an edge application server 330 and the connection further comprises a first local user plane function 320, 1608AA associated with a first proxy function and a user plane tunnel connection between a UE based client 122, 1612 and the first proxy and user plane function 320, 1608AA. The user plane tunnel connection further comprises a first source internet protocol, IP, address. In some examples the second proxy function 370, 1608AB is configured to establish a second user plane function connection between the UE based client 122, 1612 and the first user plane function 320, 1608AA. The second user plane function 370, 1608AB is further configured to obtain a second source IP address for UL data packets, wherein the second source IP is different from the first IP address. How the user plane function 370, 1608AB obtains the second source IP address is described in detail above. The second user plane function 370, 1608AB is further configured to forward UL data packets from the second user plane function 370, 1608AB to the first user plane proxy function 320, 1608AA, wherein the first IP address is replaced with the second IP address.

In some embodiments a computer program, program product or carrier comprising a computer program, the computer program comprising instructions which when executed on a processor circuit, cause the processor to perform any one of the examples or embodiments disclosed herein.

FIG. 16 shows an example of a communication system 1600 in accordance with some embodiments. In the example, the communication system 1600 includes a telecommunication network 1602 that includes an access network 1604, such as a radio access network (RAN), and a core network 1606, which includes one or more core network nodes 1608. In examples the core network nodes may include one or more of the nodes depicted in FIG. 1. In specific examples relating to one or more embodiments disclosed herein the core network 1606 includes one or more UPF/PROXY nodes, 1608AA and 1608AB. The access network 1604 includes one or more access network nodes, such as network nodes 1610a and 1610b (one or more of which may be generally referred to as network nodes 1610), or any other similar 3rd Generation Partnership Project (3GPP) access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608, 1608A) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center

(MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, for example as described in one or more embodiments disclosed herein between a UE based client, network nodes, and hosts or Servers with which the UE based client is communicating. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The UE based client application referred to herein may be implemented in one or more application programs along with one or more other functions of UE 1700 The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. In specific embodiments described herein, the network node is a user plane function and or a proxy function. However, other examples of network nodes include Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a UPF and proxy function) which may each have their own respective components. In certain scenarios in which the network node 1800 comprises multiple separate components, one or more of the separate components may be shared among several network nodes.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality. In some embodiments, the processing circuitry 1802 includes a system on a chip (SOC).

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in communication of signaling and/or data between a network node, access network, and/or UE. As illustrated, the communication interface 1806 comprises port(s)/terminal(s) 1816 to send and receive data, for example to and from a network over a wired connection. The digital data may be passed to the processing circuitry 1802. In other embodiments, the communication interface may comprise different components and/or different combinations of components. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

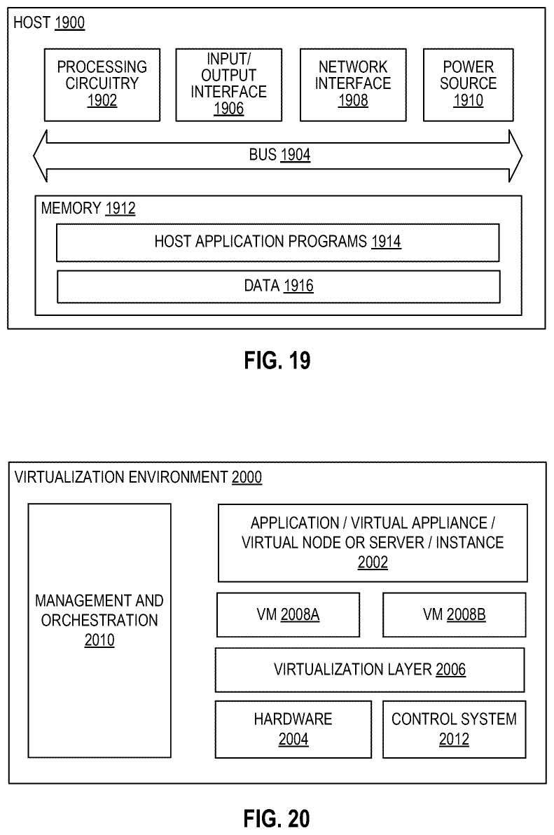

FIG. 19 is a block diagram of a host or server 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

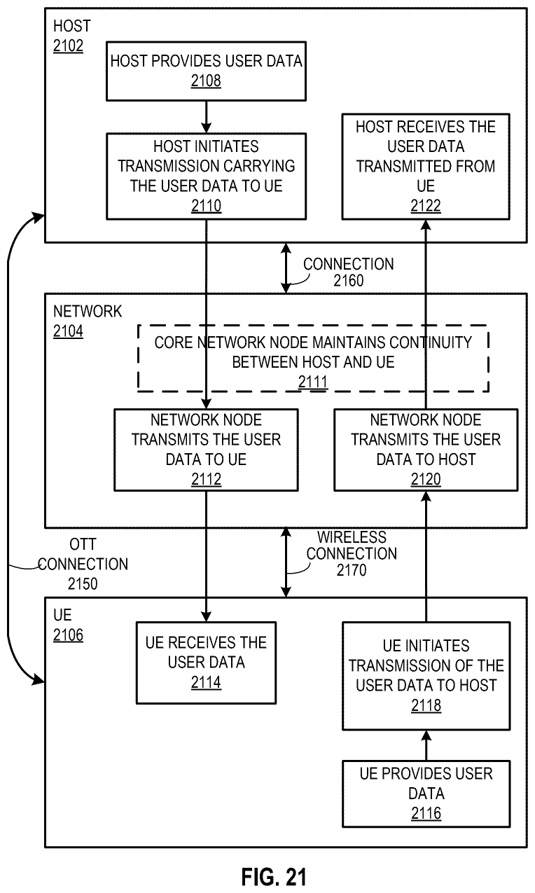

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1608A of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 passes through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network 2104 and via a wireless connection 2170 between the network 2104 and the UE 2106 to provide the connection between the host 2102 and the UE 2106. The network 2104 comprises radio network nodes (e.g. 2112, 2120) and core network nodes (e.g. 2111). Examples of the core network nodes are described in relation to FIG. 1, but in relation to the present disclosure, comprise at least UPF and Proxy functions. The connection 2160 and wireless connection 2170, over which the OTT connection 2150 may be provided, have been drawn abstractly to illustrate the communication between the host 2102 and the UE 2106 via the network 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network 2104, in accordance with the teachings of the embodiments described throughout this disclosure. Accordingly, in step 2111 a connection between the Host 2102 (server that requires Edge Connectivity is established, and the user plane is tunneled through a local proxy, Proxy1; the connection has been previously established as described above in connection with FIG. 5. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106. Accordingly, in step 2111, as a result of either a UE mobility management procedure (relocation/handover/cell change), Distributed Anchor or WIFI nomadicity or multi-homing, the UP path changes to or adds a new local PSA and the respective UPF and Proxy nodes comprised in the network 214 perform any of the actions described herein to adapt and/or maintain the UP connection path to provide enhanced service continuity.

One or more of the various embodiments improve the performance of OTT services provided to the UE 2106 using the OTT connection 2150, in which the wireless connection 2170 forms the last segment. More precisely, the teachings of these embodiments may improve the latency by shortening the overall connection path after a change to the local PDU session anchor (PSA). Other advantages are that by optimising host server instance reliability and congestion may be better controlled, providing better overall application service quality of service, throughput, real-time adaptation/service level expansion.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Numbered Example Embodiments in Relation to an OTT Service

1. A host configured to operate in a communication system to provide an over-the-top (OTT) service, the host comprising:
   processing circuitry configured to provide user data; and
   a network interface configured to initiate transmission of the user data via one or more UPF and/or Proxy function to a cellular network for transmission to a user equipment (UE), wherein the UPF and/or Proxy function and the UE comprise communication interface and processing circuitry, the communication interface and processing circuitry being configured to perform any of the steps of examples described herein corresponding to the UPF and/or
   Proxy and UE respectively.
2. The host of the previous embodiment, wherein the communication system further includes a network node configured to communicate with the UE to transmit the user data to the UE from the host.
3. The host of the previous 2 embodiments, wherein:
   the processing circuitry of the host is configured to execute a host application, thereby providing the user data; and
   the host application is configured to interact with a client application executing on the UE, the client application being associated with the host application.
4. A method implemented by a host operating in a communication system that further includes a network node, one or more UPF and/or Proxy function, and a user equipment (UE), the method comprising:
   providing user data for the UE; and
   initiating a transmission carrying the user data to the UE via the one or more UPF and/or Proxy function to a cellular network comprising the network node (e.g. RAN network node), wherein the UE and/or the one or more UPF and/or Proxy function perform any of the operations described herein to receive and continue to receive the user data from the host.
5. The method of the previous embodiment, further comprising:
   at the host, executing a host application associated with a client application executing on the UE to receive the user data from the UE.
6. The method of the previous embodiment, further comprising:
   at the host, transmitting input data to the client application executing on the UE, the input data being provided by executing the host application,
   wherein the user data is provided by the client application in response to the input data from the host application.
7. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data via one or more UPF and/or Proxy function toward a cellular network node for transmission to the UE, the one or more UPF and/or Proxy function and the network node having a communication interface and processing circuitry, the processing circuitry of the network node configured to perform any of the operations of any of the embodiments described herein to transmit and maintain connectivity for the user data from the host to the UE.
8. The communication system of the previous embodiment, further comprising:
   the network node; and/or
   the user equipment.
9. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
10. The host of the previous 2 embodiments, wherein:
   the processing circuitry of the host is configured to execute a host application, thereby providing the user data; and
   the host application is configured to interact with a client application executing on the UE, the client application being associated with the host application.
11. The host of the any of the previous 2 embodiments, wherein the initiating receipt of the user data comprises requesting the user data.
12. A method implemented by a host configured to operate in a communication system that further includes a network node and a user equipment (UE), the method comprising: at the host, initiating receipt of user data from the UE via one or more UPF and/or Proxy function, the user data originating from a transmission which the one or more UPF and/or Proxy function has received from the UE, wherein the via one or more UPF and/or Proxy function performs any of the steps of any of the embodiments described herein to receive or continue to receive the user data from the UE for the host.
13. The method of the previous embodiment, further comprising at the one or more UPF and/or Proxy function, transmitting the received user data to the host.

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-10. (canceled)

11. A method performed by a user equipment, UE, in a wireless communication system for service continuity between a client application of the UE and a server, the connection comprising an edge application server and the connection further comprising a first local user plane function and a first proxy and a user plane tunnel connection between the UE based client and the first proxy and user plane function, the user plane tunnel connection further comprising a first source internet protocol, IP, address, the method comprising:
performing a path change procedure after a connection to a second user plane function has been established;
triggering a discovery procedure to enable the connection of a second proxy associated with the second user plane function, based on the path change procedure; and
establishing a tunnel connection to the second proxy between the UE and the second proxy wherein UL data packets are routed from the second proxy to the server and bypassing the first proxy.

12. The method of claim 11 wherein the second user plane function is configured to forward UL packets to the first proxy function with a second source IP address, different to the first source IP address.

13. The method of claim 11, wherein the triggering a discovery procedure comprises providing reachability information for the second proxy local to the second user plane function.

14. (canceled)

15. The method of claim 12, wherein the second user plane function is configured to forward UL packets to the first proxy function with a second source IP address, different to the first source IP address, further comprising:
establishing a tunnel connection to the second proxy.

16-20. (canceled)

21. A method performed by a first proxy function, in a wireless communication system for service continuity between a UE-based client application and a server, the connection comprising an edge application server and the connection further comprising a first local user plane function associated with the first proxy function and a user plane tunnel connection between the UE based client and the first proxy and user plane function, the user plane tunnel connection further comprising a first source internet protocol, IP, address, the method comprising:
receiving UL data packets from a second user plane function;
detecting a change to a second IP address;
in response to detecting,
performing a path change procedure after a connection to a second user plane function has been established;
receiving UL data packets from a second user plane function.

22. The method of claim 21 wherein the second user plane function is configured to forward UL packets to the first proxy function with a second source IP address, different to the first source IP address and the performing a path change is performed in response to detecting the change of source IP address.

23-24. (canceled)

25. The method of claim 21 wherein the path change procedure comprises a Quick UDP Internet Connection, QUIC, protocol PATH_CHALLENGE message.

26. The method of claim 21, wherein the path change procedure comprises a Quick UDP Internet Connection, QUIC, protocol PATH RESPONSE message, in response to a PATH_CHALLENGE message received from the UE based client.

27. The method of claim 21, wherein the path change procedure comprises sending a message comprising reachability information for the second proxy.

28-31. (canceled)

32. A user equipment, UE, comprising a client application wherein the client application is connected to a server, the connection comprising an edge application server and the connection further comprising a first local user plane function and a first proxy and a user plane tunnel connection between the UE based client and a first proxy and user plane function, the user plane tunnel connection further comprising a first source internet protocol, IP, address, the UE configured to:
perform a path change procedure in response to a connection being established to a second user plane function configured to forward UL packets to the first proxy function with a second source IP address, different to the first source IP address; and,
trigger a discovery procedure to enable the connection of a second proxy associated with the second user plane function, based on the path change procedure
establish a tunnel connection to the second proxy between the UE and the second proxy wherein UL data packets are routed from the second proxy to the server and bypassing the first proxy.

33. (canceled)

34. (canceled)

35. (canceled)

36. A second proxy function in a wireless communication system for service continuity between a UE-based client application and a server, the connection comprising an edge application server and the connection further comprising a first local user plane function associated with a first proxy function and a user plane tunnel connection between a UE based client and the first proxy and user plane function, the user plane tunnel connection further comprising a first source internet protocol, IP, address, the second proxy function configured to:
establish a second user plane function connection between the UE based client and the first user plane connection;
obtain a second source IP address for UL data packets, wherein the second source IP is different from the first IP address;
forward UL data packets from the second user plane function to the first user plane proxy function, wherein the first IP address is replaced with the second IP address.

37. A program product or carrier comprising a computer program, the computer program comprising instructions which when executed on a processor circuit, cause the processor to perform the method of claim 11.
